(19) United States
(12) Patent Application Publication
(10) Pub. No.: US 2026/0308034 A1
(43) Pub. Date: Oct. 8, 2026

(54) Method for Complete Sulfate and Metal Removal from Produced Water Using a Three-Step Treatment Process for Reinjection

(71) Applicant: Felipe Lembcke, Granbury, TX (US)

(72) Inventor: Felipe Lembcke, Granbury, TX (US)

(73) Assignee: Molecular Filtration, Inc., Granbury, TX (US)

(21) Appl. No.: 19/171,255

(22) Filed: Apr. 5, 2025

(51) Int. Cl. C02F 5/08; C02F 101/10; C02F 101/30; C02F 103/10

(52) U.S. Cl. CPC C02F 5/08; C02F 2101/101; C02F 2101/30; C02F 2103/10; C02F 2303/18; C02F 2305/023

(57) ABSTRACT

A method for treating produced water for reinjection into oil reservoirs by removing sulfates, metals, sulfur compounds, and microbial contaminants. Step one adds barium hydroxide to form barium sulfate. Sodium sulfide and carbon dioxide may be used to remove metals and stabilize excess barium. Step two uses a manganese-doped ceramic contactor and oxidants such as air, oxygen, hydrogen peroxide, or UV light to convert sulfur compounds to elemental sulfur. Step three filters the stream through an organophobic ceramic membrane to remove solids, organics, and bacteria. Hydrazine is added before filtration to remove dissolved oxygen. The process yields clean, scale-free water suitable for reinjection under high salinity. It offers a reliable, compact solution for produced water reuse and protects oilfield infrastructure from scaling and fouling.

### CROSS-REFERENCES TO RELATED APPLICATIONS

This application claims priority to and incorporates by reference the following related applications:

1. U.S. patent application Ser. No. 19/097,065, filed on Apr. 1, 2025, titled “Catalytic Ceramic Contactor for Sulfur Removal in Aqueous Systems.” This application describes the catalytic ceramic contactor technology used in Step 2 of the present invention for the oxidation and transformation of sulfur compounds into filterable elemental sulfur.

2. International Patent Application No. PCT/US2014/063198, published as WO 2015/066347 A1 on May 7, 2015, titled “Separation of Organic Compounds from Liquid.” This application discloses the organophobic ceramic membrane used in Step 3 of the present invention for the separation of non-polar organics, sulfur-reducing bacteria, and iron-reducing bacteria from produced water.

The technologies disclosed in these prior applications form integral components of the present invention and are incorporated herein by reference.

### BACKGROUND OF THE INVENTION

The treatment and reuse of produced water from oil and gas operations represents a significant technical and environmental challenge, particularly when the treated water is intended for reinjection into the reservoir. Produced water often contains high levels of dissolved solids, particularly sodium and chloride, as well as complex mixtures of sulfate, barium, strontium, calcium, iron, and other heavy metals. In addition, organosulfur compounds, hydrogen sulfide, and bacteria such as sulfur-reducing bacteria (SRB) and iron-reducing bacteria (IRB) may be present. These components present a high risk of fouling, corrosion, and most critically, scale formation in the wellbore and reservoir during reinjection.

Conventional treatment processes often fall short due to their inability to fully remove sulfate ions and scale-forming metals under high-salinity conditions, or they require extensive chemical use, large energy inputs, or complex maintenance procedures. Processes that rely on filtration alone are typically ineffective against dissolved ionic species, while those based on ion exchange or membrane separation are limited by salinity and fouling.

A need exists for a straightforward, robust, and scalable method that can effectively and economically remove sulfates, scale-forming metals, and other harmful components from produced water, rendering it suitable for reinjection. The present invention addresses this need by providing a three-step treatment process that combines chemical precipitation, catalytic oxidation, and ceramic membrane filtration in a unique and synergistic sequence.

### PRIOR ART

Multiple methods have been proposed for the treatment of produced water, particularly for the purpose of sulfate and heavy metal removal prior to reinjection. However, each of these technologies presents significant limitations when applied to high-salinity, high-complexity water typical of oilfield production.
1. U.S. Pat. No. 8,961,775 describes a method for removing sulfate from water using anion exchange resins, but performance declines sharply at high salinity levels due to competition with chloride ions and frequent regeneration requirements.
2. U.S. Patent Application No. 2016/0123456 discloses a process involving reverse osmosis and nanofiltration membranes, which can remove divalent ions like sulfate and barium. However, these membranes suffer from rapid fouling and scaling in oilfield conditions and require pretreatment systems that are costly and complex.
3. U.S. Pat. No. 9,123,456 covers the use of magnesium compounds to precipitate sulfate as magnesium sulfate. This process is not selective and leaves behind critical scale-forming species such as barium and strontium.
4. U.S. Pat. No. 10,567,890 introduces a multi-stage treatment system using chemical oxidizers and softening agents. While effective under laboratory conditions, field applications are limited due to chemical cost and handling challenges.
5. WO 2015/066347 A1, related to the use of organophobic ceramic membranes, provides efficient separation of non-polar organics and biological contaminants, but it does not address dissolved ionic species such as sulfate and heavy metals.

The present invention differs fundamentally by introducing a stepwise, integrated solution that fully eliminates sulfate and heavy metals via controlled chemical precipitation and oxidation, followed by advanced membrane separation. This novel approach allows for reliable, low-maintenance reinjection of produced water while preventing downhole scaling and operational damage.

### SUMMARY OF THE INVENTION

The present invention provides a comprehensive three-step method for the treatment of produced water to enable safe and sustainable reinjection into oil reservoirs. The method is specifically designed to eliminate sulfate ions, heavy metals, sulfur compounds, and microbial contaminants from high-salinity produced water streams, which are typically difficult and costly to treat.

Step 1 involves the chemical precipitation of sulfate and scale-forming metals using barium hydroxide. Sulfate is precipitated as insoluble barium sulfate, and any excess barium is subsequently precipitated as barium carbonate via carbon dioxide injection. Optional sodium sulfide may be added to precipitate trace heavy metals such as zinc, manganese, and molybdenum. This step raises the pH and removes the majority of scale precursors and metals.

Step 2 utilizes a catalytic ceramic contactor impregnated with manganese oxide. In this step, oxidizing agents such as air, pure oxygen, hydrogen peroxide, or ultraviolet light are introduced to convert residual hydrogen sulfide and organosulfur compounds into filterable elemental sulfur or non-scaling sulfate. This oxidative treatment neutralizes biologically and chemically active sulfur species that would otherwise pose risks during reinjection.

Step 3 consists of cross-flow filtration using an organophobic ceramic membrane. This membrane separates all suspended solids, including barium sulfate, barium carbonate, elemental sulfur, metal hydroxides, and other precipitated contaminants. It also removes residual non-polar organics and microorganisms such as sulfur-reducing and iron-reducing bacteria. The result is particle-free, scale-safe, and microbiologically stable water suitable for direct reinjection.

This method delivers a simple, efficient, and scalable solution for treating even the most challenging produced water, supporting water reuse, reducing operational costs, and protecting reservoir integrity.

### BRIEF DESCRIPTION OF THE DRAWINGS

FIG. 1 is a process flow diagram illustrating the three-step treatment method for produced water reinjection.

The figure shows the sequential treatment steps beginning with chemical precipitation, followed by catalytic oxidation, and concluding with membrane filtration. Produced water is first treated with barium hydroxide, carbon dioxide, and optional sodium sulfide to precipitate sulfates and heavy metals as insoluble solids. The resulting slurry is then passed through a catalytic ceramic contactor, where oxidizing agents such as air, hydrogen peroxide, or UV light convert remaining sulfur compounds into elemental sulfur or sulfate. Subsequently, hydrazine is injected upstream of an organophobic ceramic membrane to remove dissolved oxygen before final filtration. The membrane step separates all precipitated solids and colloids, delivering treated, scale-free water suitable for reinjection into oil reservoirs.

Solids captured in the process are directed to a filter press and may be sent to a metal refinery or disposed of safely.

### DETAILED DESCRIPTION OF THE INVENTION

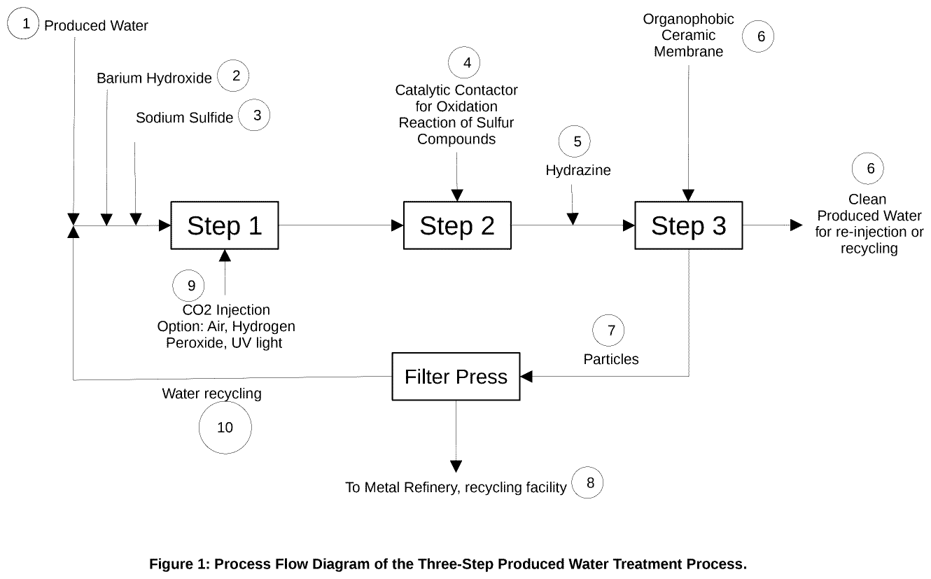

The present invention provides a novel, three-step process for treating produced water to make it suitable for reinjection into oil and gas reservoirs. As shown in FIG. 1, the system addresses the challenges of high-salinity water containing sulfate ions, heavy metals, sulfur compounds, and microbial contaminants. Each step is numerically identified in the flow diagram and designed to work in synergy.

### Step 1: Chemical Precipitation

Produced water [1] is introduced into the system along with barium hydroxide [2] to precipitate sulfate as insoluble barium sulfate (BaSO₄). Optional sodium sulfide [3] is added to selectively precipitate trace metals (e.g., Zn²⁺, Mn²⁺, Mo⁶⁺) as sulfides. Carbon dioxide [9] is injected to react with excess barium ions, forming barium carbonate (BaCO₃). This step raises the pH to 10-11, supporting complete metal precipitation. The water from this stage contains suspended solids (BaSO₄, BaCO₃, metal sulfides) and moves to Step 2.

### Step 2: Catalytic Oxidation

The partially treated water flows into a catalytic ceramic contactor [4] impregnated with manganese oxide. This contactor facilitates oxidation reactions when exposed to oxidants such as air, pure oxygen, hydrogen peroxide, or ultraviolet light [9]. Sulfur compounds including hydrogen sulfide (H₂S), mercaptans, disulfides, and thiophenes are oxidized into elemental sulfur or non-scaling sulfate. This step neutralizes chemically and biologically active sulfur species and prepares the stream for membrane separation.

### Step 3: Ceramic Membrane Filtration

Hydrazine [5] is injected before filtration to eliminate dissolved oxygen. The water then passes through an organophobic ceramic membrane [6], which separates all remaining particles, including elemental sulfur, barium salts, metal hydroxides, non-polar organics, and microorganisms such as sulfur-reducing bacteria (SRB) and iron-reducing bacteria (IRB). The clean water [6] is now free from scale-forming species and is suitable for reinjection or recycling.

### Solids Handling

The retained concentrate, containing particles [7], is routed to a filter press for dewatering. This produces a solid cake that may be sent to a metal refinery or disposal facility [8]. The filtered water exiting the press can be recycled [10] back into the system as needed.

This three-step process offers a compact, chemically efficient, and scalable solution for produced water treatment. It effectively removes sulfates, metals, sulfur species, and microorganisms while producing clean water suitable for reinjection eliminating scale risks and enabling sustainable reuse in oilfield operations.

1. A method for treating produced water for reinjection into oil reservoirs, comprising:
(a) introducing barium hydroxide into produced water to precipitate sulfate ions as barium sulfate;
(b) injecting carbon dioxide to convert excess barium ions into barium carbonate;
(c) optionally adding sodium sulfide to precipitate trace heavy metals as metal sulfides;
(d) passing the treated water through a catalytic ceramic contactor impregnated with manganese oxide while introducing an oxidizing agent selected from the group consisting of air, oxygen, hydrogen peroxide, and ultraviolet light, to oxidize sulfur compounds into elemental sulfur or sulfate;
(e) injecting hydrazine into the water stream to remove dissolved oxygen;
(f) filtering the water through an organophobic ceramic membrane to remove all precipitated solids, elemental sulfur, non-polar organics, sulfur-reducing bacteria, and iron-reducing bacteria.

2. The method of claim 1, wherein the barium hydroxide is added in stoichiometric excess to ensure complete sulfate precipitation.

3. The method of claim 1, wherein the catalytic ceramic contactor is a tubular structure with manganese oxide embedded on the inner surfaces.

4. The method of claim 1, wherein the hydrazine is dosed to maintain a dissolved oxygen concentration of less than 1 ppm in the final treated water.

5. The method of claim 1, wherein the organophobic ceramic membrane has a pore size in the range of 8 to 200 nanometers.

6. The method of claim 1, further comprising collecting the rejected solids from the membrane and processing them via a filter press.

7. The method of claim 1, wherein the treated water has no detectable sulfate, barium, strontium, or suspended solids, making it suitable for scale-free reinjection.
